(19) United States
(12) Patent Application Publication
(10) Pub. No.: US 2022/0300541 A1
(43) Pub. Date: Sep. 22, 2022

(54) COMPUTER-READABLE RECORDING MEDIUM STORING LOG MANAGEMENT PROGRAM, INFORMATION PROCESSING APPARATUS, AND LOG MANAGEMENT METHOD

(71) Applicant: FUJITSU LIMITED, Kawasaki-shi (JP)

(72) Inventors: Tomoki Ogawa, Kawasaki (JP); KENICHIROU SHIMOGAWA, Numazu (JP); Sayako Kondoh, Yokohama (JP)

(73) Assignee: FUJITSU LIMITED, Kawasaki-shi (JP)

(21) Appl. No.: 17/533,168

(22) Filed: Nov. 23, 2021

(30) Foreign Application Priority Data
Mar. 19, 2021 (JP) 2021-046092

(51) Int. Cl. G06F 16/332; G06F 40/10; G06F 16/18; G06F 16/17

(52) U.S. Cl. CPC G06F 16/3329; G06F 40/10; G06F 16/1805; G06F 16/1734

(57) ABSTRACT

A recording medium stores a log management program for causing a computer to execute a process of: extracting logs of target log information including a predetermined character string from first logs; storing a character string of a fixed portion and a character string of a variable portion included in each of the logs of the target log information thus extracted; extracting logs of candidate log information including the predetermined character string from a plurality of second logs; identifying one or more logs of monitoring target log information from the logs of the candidate log information based on monitoring necessity information specifying whether each of the character strings of the fixed portions and the character strings of the variable portions stored in the memory is a character string required to be monitored; and transmitting the identified one or more logs of the monitoring target log information to a different apparatus.

### CROSS-REFERENCE TO RELATED APPLICATION

This application is based upon and claims the benefit of priority of the prior Japanese Patent Application No. 2021-46092, filed on Mar. 19, 2021, the entire contents of which are incorporated herein by reference.

### FIELD

The embodiments discussed herein are related to a computer-readable recording medium storing a log management program, an information processing apparatus, and a log management method.

### BACKGROUND

For example, when a business entity which provides services to users (hereafter, also simply referred to as a business entity) operates a business system required for providing the services, the business entity also monitors an operation status of the business system. When the business entity detects the occurrence of an abnormality in the business system, the business entity takes a required countermeasure against the detected abnormality.

International Publication Pamphlet No. WO 2013/136418 and Japanese Laid-open Patent Publication Nos. 2014-153721 and 2014-191799 are disclosed as related art.

### SUMMARY

According to an aspect of the embodiments, a non-transitory computer-readable recording medium stores a log management program for causing a computer to execute a process of: extracting a plurality of logs of target log information including a predetermined character string from a plurality of first logs; storing, into a memory, a character string of a fixed portion and a character string of a variable portion included in each of the plurality of logs of the target log information thus extracted; extracting a plurality of logs of candidate log information including the predetermined character string from a plurality of second logs; identifying one or more logs of monitoring target log information from the plurality of logs of the candidate log information based on monitoring necessity information specifying whether each of the character strings of the fixed portions and the character strings of the variable portions stored in the memory is a character string required to be monitored; and transmitting the identified one or more logs of the monitoring target log information to a different apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a configuration of an information processing system;

FIG. 2 is a diagram for explaining a hardware configuration of a monitoring apparatus;

FIG. 3 is a diagram for explaining a hardware configuration of a physical machine;

FIG. 4 is a functional block diagram of the physical machine;

FIG. 5 is a functional block diagram of the monitoring apparatus;

FIG. 6 is a flowchart for explaining an overview of log management processing according to a first embodiment;

FIG. 7 is a flowchart for explaining details of the log management processing according to the first embodiment;

FIG. 8 is a flowchart for explaining the details of the log management processing according to the first embodiment;

FIG. 9 is a flowchart for explaining the details of the log management processing according to the first embodiment;

FIG. 10 is a flowchart for explaining the details of the log management processing according to the first embodiment;

FIG. 11 is a flowchart for explaining the details of the log management processing according to the first embodiment;

FIG. 12 is a flowchart for explaining the details of the log management processing according to the first embodiment;

FIG. 13 is a flowchart for explaining the details of the log management processing according to the first embodiment;

FIG. 14 is a diagram for explaining a specific example of monitoring target information;

FIGS. 15A and 15B are diagrams for explaining specific examples of extracted log information and fixed character string information;

FIGS. 16A and 16B are diagrams for explaining specific examples of the extracted log information and the fixed character string information;

FIGS. 17A to 17C are diagrams for explaining specific examples of the extracted log information, the fixed character string information, and the variable character string information;

FIGS. 18A to 18C are diagrams for explaining specific examples of the extracted log information, the fixed character string information, and the variable character string information;

FIGS. 19A to 19C are diagrams for explaining specific examples of the extracted log information, the fixed character string information, and the variable character string information;

FIGS. 20A and 20B are diagrams for explaining specific examples of monitoring necessity information;

FIG. 21 is a functional block diagram of a physical machine according to according second embodiment;

FIG. 22 is a flowchart for explaining log management processing according to the second embodiment;

FIG. 23 is a flowchart for explaining the log management processing according to the second embodiment;

FIG. 24 is a flowchart for explaining the log management processing according to the second embodiment;

FIG. 25 is a flowchart for explaining the log management processing according to the second embodiment;

FIG. 26 is a flowchart for explaining the log management processing according to the second embodiment; and

FIGS. 27A to 27C are diagrams for explaining specific examples of extracted log information, fixed character string information, and variable character string information according to the second embodiment.

### DESCRIPTION OF EMBODIMENTS

For example, a monitoring apparatus that monitors the operation status of the business system (hereafter, also simply referred to as a monitoring apparatus) checks logs output by the business system in operation (hereafter, also referred to as log information) to identify a log indicating the occurrence of an abnormality in the business system, and makes a notification indicating the content of the identified log to the business entity. Then, based on the content of the received notification, the business entity takes a required countermeasure for the business system.

Thus, the business entity may reduce the influence of the occurrence of the abnormality in the business system.

The aforementioned identification of a log indicating the occurrence of an abnormality is done, for example, by comparing the logs output by the business system with predetermined definition values. For example, the monitoring apparatus identifies a log including any of the definition values from the logs output by the business system in operation, thereby identifying the log indicating the occurrence of the abnormality in the business system.

However, the definition values described above are required to be created based on the contents in a huge number of logs sequentially output from the business system. The logs output from the business system may be changed along with version upgrading or the like of an operating system (OS) and applications running on the business system.

Thus, the business entity may not easily manage the business system because of difficulty in creating the definition values as described above.

In one aspect, an object of the disclosure is to provide a log management program, an information processing apparatus, and a log management method that facilitate management of a business system.

[Configuration of Information Processing System in First Embodiment]

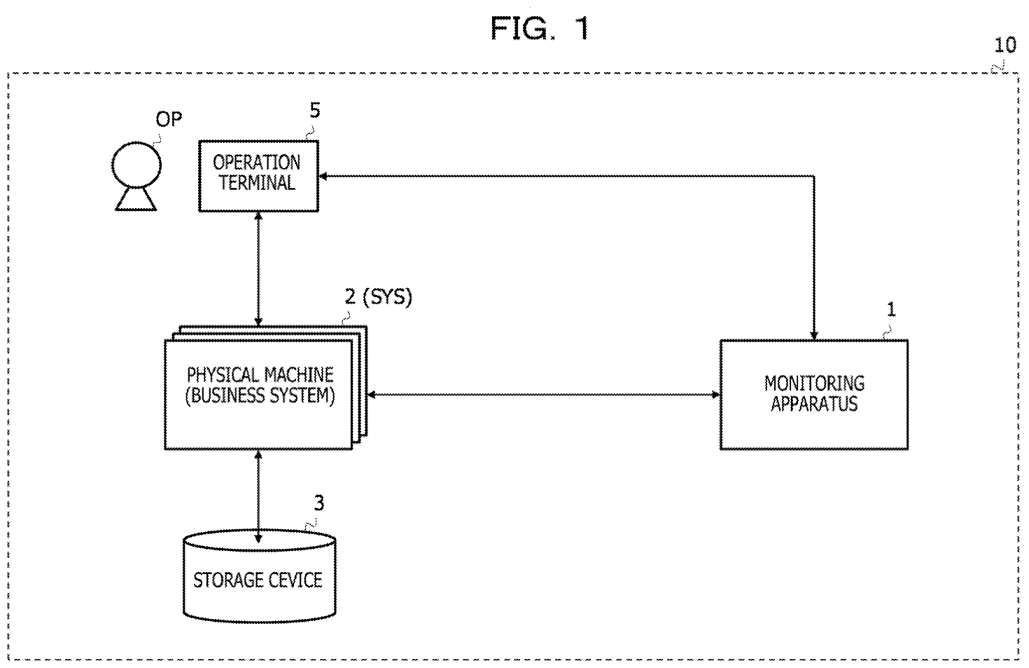

First, a configuration of an information processing system 10 will be described. FIG. 1 is a diagram for explaining the configuration of the information processing system 10.

The information processing system 10 illustrated in FIG. 1 includes, for example, a monitoring apparatus 1, multiple physical machines 2, a storage device 3, and an operation terminal 5.

The multiple physical machines 2 are, for example, of a physical machine group on which a business system SYS for providing services to users by a business entity runs. The multiple physical machines 2 are, for example, of a physical machine group which operates multiple virtual machines (VMs) on which the business system SYS runs. Each of the multiple physical machines 2 stores, for example, log information output from the business system SYS into the storage device 3 (for example, a database).

The operation terminal 5 is, for example, a personal computer (PC) with which an operator OP who monitors the business system SYS (hereafter, also simply referred to as an operator OP) inputs and views required information, for example.

The monitoring apparatus 1 includes, for example, one or more physical machines and identifies log information indicating the occurrence of an abnormality in the business system SYS from log information output from the business system SYS. The monitoring apparatus 1 transmits, for example, a notification indicating the content of the identified log information to the operation terminal 5.

Thus, for example, the operator OP is enabled to take a required countermeasure for the business system SYS by viewing the operation terminal 5 on which the content of the notification received from the monitoring apparatus 1 is output. Therefore, the operator OP may reduce an influence due to the occurrence of an abnormality in the business system SYS.

For example, the monitoring apparatus 1 compares the log information output by the business system SYS with definition values created in advance to identify the log information indicating the occurrence of an abnormality in the business system SYS.

However, the definition values described above have to be created based on a huge number of logs of log information sequentially output from the business system SYS. The log information output by the business system SYS may be changed along with version upgrading or the like of the OS or applications running on the business system SYS.

Thus, the operator OP may not easily manage the business system SYS because of difficulty in creating the definition values as described above.

The monitoring apparatus 1 according to the present embodiment extracts multiple logs of log information each including a predetermined character string (hereafter, also referred to as multiple logs of target log information) from multiple logs of log information output from the business system SYS (hereafter, also referred to as multiple logs of first log information). The predetermined character string is, for example, one or more character strings determined in advance by the operator OP. The monitoring apparatus 1 stores the character string of a fixed portion and the character string of a variable portion included in each of the extracted multiple logs of the target log information into a storage unit.

After that, the monitoring apparatus 1 extracts multiple logs each including the predetermined character string (hereafter, also referred to as multiple logs of candidate log information) from multiple logs of log information output from the business system SYS (hereafter, also referred to as multiple logs of second log information). Then, the monitoring apparatus 1 identifies one or more monitoring target logs from the extracted multiple candidate logs based on information indicating whether each of the character strings of the fixed portions and the character strings of the variable portions stored in the storage unit is a character string required to be monitored (hereafter, also referred to as monitoring necessity information). The monitoring apparatus 1 transmits, for example, the identified one or more monitoring target logs to the operation terminal 5 (hereafter, also referred to as a different apparatus).

For example, the monitoring apparatus 1 according to the present embodiment stores the character strings included in the multiple logs of the target log information extracted from the multiple logs of the first log information into the storage unit such that a character string of a fixed portion and a character string of a variable portion in each of the character strings are stored separately from each other. Meanwhile, for example, the operator OP inputs monitoring necessity information to the monitoring apparatus 1, the monitoring necessity information specifying whether each of the character strings of the fixed portions and the character strings of the variable portions, which are stored in the storage unit, is a character string required to be monitored.

After that, for example, for each of the multiple logs of the candidate log information extracted from the multiple logs of the second log information different from the multiple logs of the first log information, the monitoring apparatus 1 determines whether each of the character string of the fixed portion and the character string of the variable portion included in the concerned log of the candidate log information is a character string required to be monitored by referring to the monitoring necessity information input by the operator OP. The monitoring apparatus 1 identifies one or more monitoring target logs from the multiple logs of the candidate log information based on the respective determination results for the multiple logs of the candidate log information.

In this way, the monitoring apparatus 1 according to the present embodiment is capable of generating, from the log information, definition values for use to monitor the business system SYS. Thus, it is possible for the operator OP to reduce the workload required for creating and updating the definition values, and to easily manage the business system SYS.

The storage unit for storing the character string of the fixed portion in each log of the target log information (hereafter, also referred to as a first storage unit) may be different from the storage unit for storing the character string of the variable portion in each log of the target log information (hereafter, also referred to as a second storage unit).

[Hardware Configuration of Information Processing System]

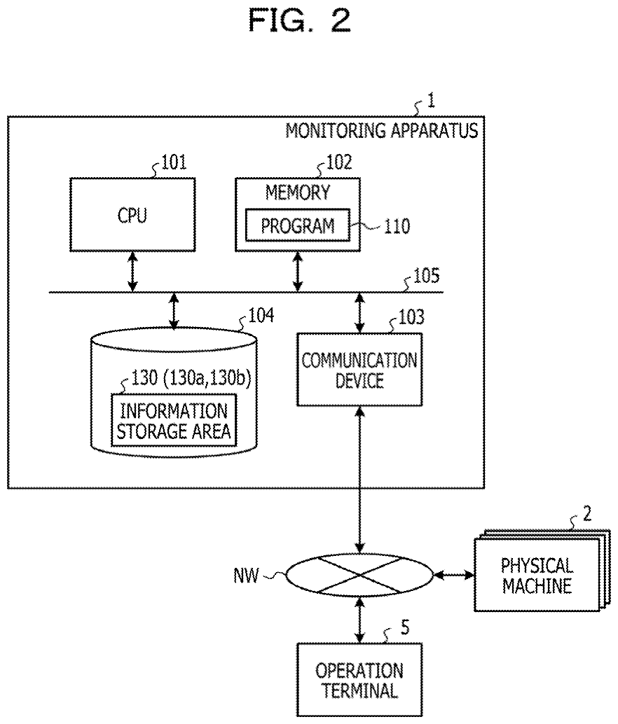

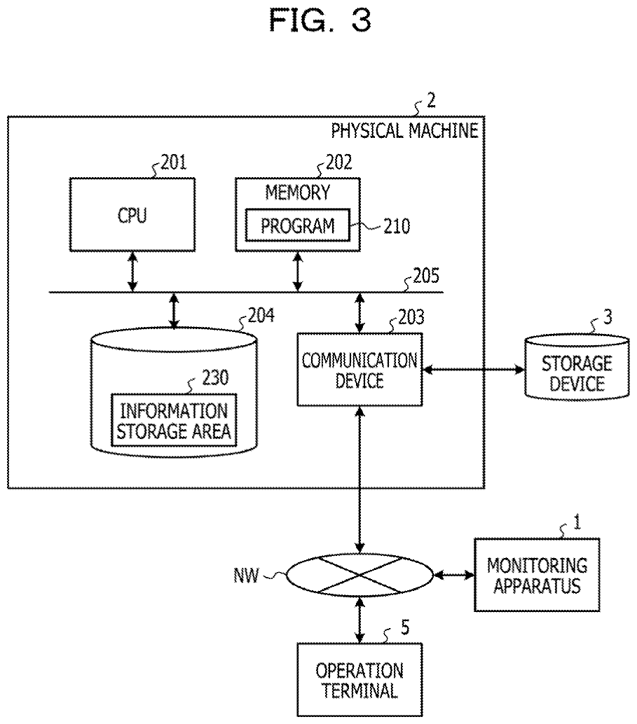

Next, a hardware configuration of the information processing system 10 will be described. FIG. 2 is a diagram for explaining a hardware configuration of the monitoring apparatus 1. FIG. 3 is a diagram for explaining a hardware configuration of the physical machine 2.

[Hardware Configuration of Monitoring Apparatus]

First, the hardware configuration of the monitoring apparatus 1 will be described.

As illustrated in FIG. 2, the monitoring apparatus 1 includes a central processing unit (CPU) 101 that is a processor, a memory 102, a communication device 103, and a storage medium 104. These units are coupled to each other via a bus 105.

The storage medium 104 includes, for example, a program storage area (not illustrated) that stores a program 110 for executing processing of managing the log information output from the business system SYS (hereafter, also referred to as log management processing). The storage medium 104 includes, for example, an information storage area 130 that stores information for use to execute the log management processing. The information storage area 130 may include, for example, an information storage area 130a serving as the first storage unit and an information storage area 130b serving as the second storage unit. The information storage area 130a and the information storage area 130b may also be the same information storage area. The storage medium 104 may be, for example, a hard disk drive (HDD) or a solid-state drive (SSD).

The CPU 101 executes the program 110 loaded from the storage medium 104 to the memory 102 to perform the log management processing.

For example, the communication device 103 communicates with the multiple physical machines 2 and the operation terminal 5 via a network NW.

[Hardware Configuration of Physical Machine]

Next, a hardware configuration of the physical machine 2 will be described.

As illustrated in FIG. 3, the physical machine 2 includes a CPU 201 that is a processor, a memory 202, a communication device 203, and a storage medium 204. These units are coupled to each other via a bus 205.

The storage medium 204 includes, for example, a program storage area (not illustrated) that stores a program 210 for performing the log management processing. The storage medium 204 also includes, for example, an information storage area 230 (hereafter, also referred to as a storage unit 230) that stores information for use to execute the log management processing. The storage medium 204 may be, for example, an HDD or an SSD.

The CPU 201 executes the program 210 loaded from the storage medium 204 to the memory 202 to perform the log management processing.

The communication device 203 communicates with, for example, the monitoring apparatus 1 and the operation terminal 5 via the network NW. The communication device 203 communicates with, for example, the storage device 3.

[Functions of Information Processing System]

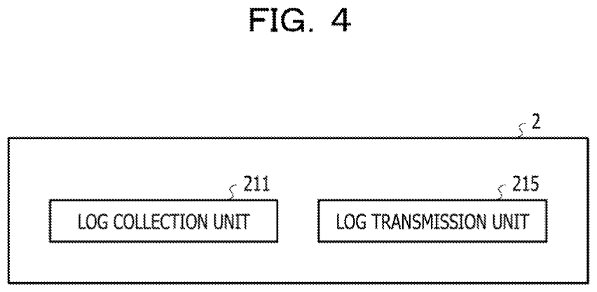

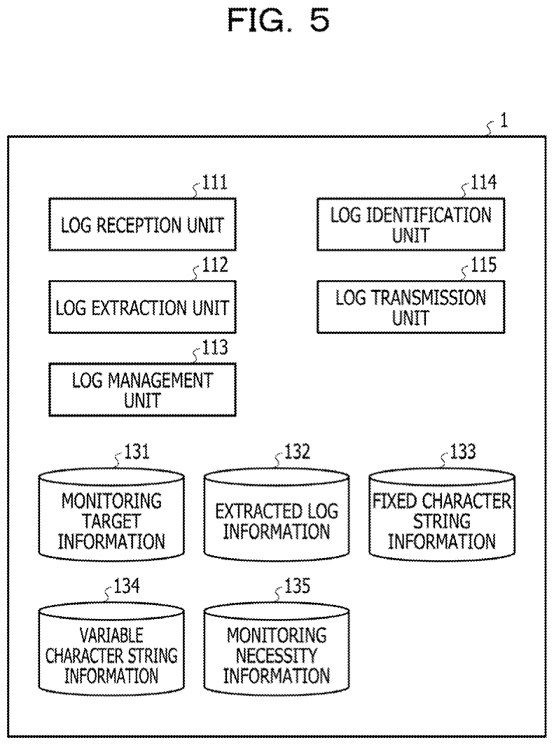

Next, functions of the information processing system 10 will be described. FIG. 4 is a functional block diagram of the physical machine 2. FIG. 5 is a functional block diagram of the monitoring apparatus 1. FIG. 5 may be rephrased as a block diagram illustrating functions involved in execution of the log management processing among the functions of the physical machine 2.

[Functions of Physical Machine]

First, functions of the physical machine 2 will be described.

As illustrated in FIG. 4, the physical machine 2 achieves various functions including a log collection unit 211 and a log transmission unit 215 through organic collaboration of hardware such as the CPU 201 and the memory 202 with the program 210, for example.

The log collection unit 211 of each physical machine 2 collects log information output from the business system SYS running on the physical machine 2.

The log transmission unit 215 transmits the log information collected by the log collection unit 211 to the monitoring apparatus 1 and the storage device 3.

[Functions of Monitoring Apparatus]

Next, functions of the monitoring apparatus 1 will be described.

As illustrated in FIG. 5, the monitoring apparatus 1 achieves various functions including a log reception unit 111, a log extraction unit 112, a log management unit 113, a log identification unit 114, and a log transmission unit 115 through organic collaboration of hardware such as the CPU 101 and the memory 102 with the program 110, for example.

For example, as illustrated in FIG. 5, the monitoring apparatus 1 stores, in an information storage area 130, monitoring target information 131, extracted log information 132, fixed character string information 133, variable character string information 134, and monitoring necessity information 135.

First, description will be given of functions for performing processing of generating the fixed character string information 133 and the variable character string information 134 (hereafter, also referred to as information generation processing) in the log management processing.

The log reception unit 111 receives, for example, multiple logs of log information (multiple logs of first log information) transmitted from each of the multiple physical machines 2.

For example, by referring to the monitoring target information 131 stored in the information storage area 130, the log extraction unit 112 extracts multiple logs of log information (multiple logs of target log information) each including any of character strings (predetermined character strings) specified in the monitoring target information 131 from the multiple logs of the log information received by the log reception unit 111. The monitoring target information 131 is, for example, information specifying each monitoring target character string determined in advance by the operator OP. For example, the log extraction unit 112 stores the extracted multiple logs of the log information into the information storage area 130 as the extracted log information 132.

For example, the log management unit 113 stores a character string of a fixed portion included in each of the multiple logs of the log information extracted by the log extraction unit 112 into the information storage area 130 (information storage area 130a) as the fixed character string information 133. The character string of a fixed portion included in each log of the log information is, for example, a character string specifying what event occurred to cause output of the concerned log of the log information, and is a character string determined in advance for each type of the log information (the same character string is output for the same type of the log information). Processing of identifying the character string of a fixed portion from the character string included in each log of the log information will be described later.

The log management unit 113 stores a character string of a variable portion included in each of the multiple logs of the log information extracted by the log extraction unit 112 into the information storage area 130 (information storage area 130b) as the variable character string information 134.

The character string of a variable portion included in each log of the log information is, for example, a character string specifying a piece of hardware or software that caused output of the concerned log of the log information, and is a character string that may differ among logs in the log information (different character strings may be output even for logs of the same type of the log information). Processing of identifying the character string of a variable portion from the character string included in each log of the log information will be described later.

For example, when the operator OP inputs the monitoring necessity information 135 specifying whether each character string in the fixed character string information 133 and the variable character string information 134 stored in the information storage area 130 is a character string required to be monitored, the log management unit 113 stores the input monitoring necessity information 135 into the information storage area 130.

Next, description will be given of functions for performing processing of monitoring the log information by using the fixed character string information 133 and the variable character string information 134 (hereafter, also referred to as log monitoring processing) in the log management processing.

The log reception unit 111 receives, for example, multiple logs of the log information (multiple logs of second log information) transmitted from each of the multiple physical machines 2.

For example, by referring to the monitoring target information 131 stored in the information storage area 130, the log extraction unit 112 extracts multiple logs of log information (multiple logs of candidate log information) each including any of character strings (predetermined character strings) specified in the monitoring target information 131 from the multiple logs of the log information received by the log reception unit 111.

By referring to the fixed character string information 133, the variable character string information 134, and the monitoring necessity information 135 stored in the information storage area 130, the log identification unit 114 identifies log information (monitoring target log information) required to be monitored from the multiple logs of the log information extracted by the log extraction unit 112.

For example, by referring to the fixed character string information 133 and the variable character string information 134 stored in the information storage area 130, the log identification unit 114 identifies a character string of a fixed portion and a character string of a variable portion included in each of the multiple logs of the log information extracted by the log extraction unit 112. By referring to the monitoring necessity information 135 stored in the information storage area 130, the log identification unit 114 identifies, as monitoring target log information, a log including the character string of the fixed portion and the character string of the variable portion, both of which are character strings required to be monitored, from among the multiple logs of the log information extracted by the log extraction unit 112.

For example, the log transmission unit 115 transmits the monitoring target log information identified by the log identification unit 114 to the operation terminal 5.

[Overview of First Embodiment]

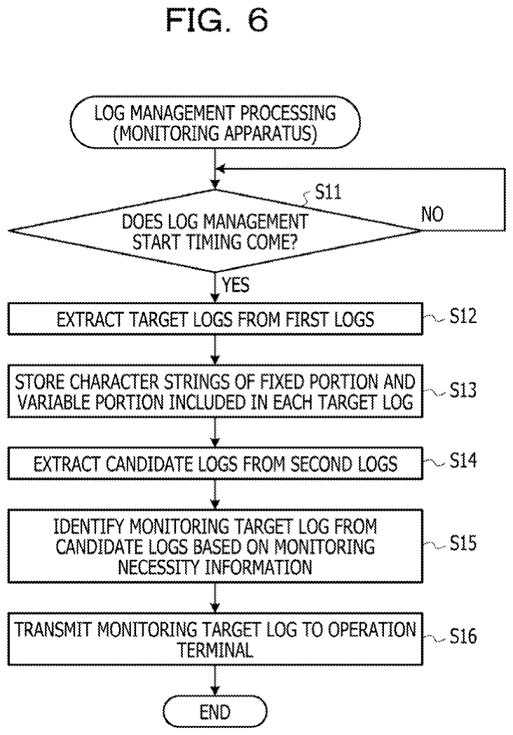

Next, an overview of a first embodiment will be described. FIG. 6 is a flowchart for explaining an overview of log management processing according to the first embodiment.

As illustrated in FIG. 6, for example, the monitoring apparatus 1 waits until a log management start timing comes (NO in S11). The log management start timing may be, for example, a timing at which the operator OP inputs, to the monitoring apparatus 1, information instructing a start of monitoring (management) of the business system SYS.

When the log management start timing comes (YES in S11), the monitoring apparatus 1 extracts multiple logs of the target log information each including a predetermined character string from the multiple logs of the first log information (S12).

For all the multiple logs of the target log information extracted in the process in S12, the monitoring apparatus 1 stores the character string of the fixed portion included in each log of the target log information into the information storage area 130a and stores the character string of the variable portion included in each log of the target log information into the information storage area 130b (S13).

The monitoring apparatus 1 extracts the multiple logs of the candidate log information including the predetermined character strings from the multiple logs of the second log information (S14).

The monitoring apparatus 1 identifies one or more logs of the monitoring target log information from the multiple logs of the candidate log information extracted in the process in S14 based on the monitoring necessity information 135 specifying whether each of the character strings of the fixed portions and the character strings of the variable portions stored in the process in S13 is a character string required to be monitored (S15).

For example, the monitoring apparatus 1 transmits the one or more logs of the monitoring target log information identified in the process in S15 to the operation terminal 5 (S16).

In this way, the monitoring apparatus 1 according to the present embodiment is capable of generating, from the log information, the definition values (monitoring necessity information 135) for use to monitor the business system SYS. Thus, for example, it is possible for the operator OP to reduce a work burden for manually creating and updating the definition values, and to easily manage the business system SYS.

[Detailed Description of First Embodiment]

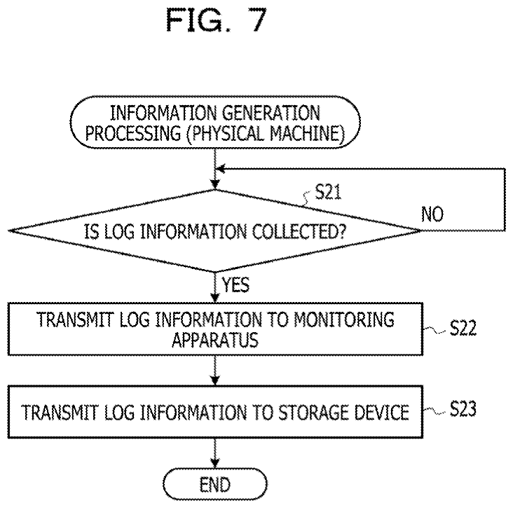

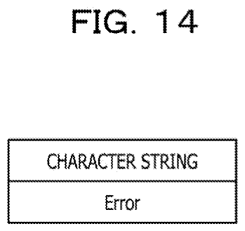

Next, details of the first embodiment will be described. FIGS. 7 to 13 are flowcharts for explaining details of the log management processing according to the first embodiment. FIGS. 14 to 20B are diagrams for explaining the details of the log management processing according to the first embodiment.

[Information Generation Processing]

First, information generation processing will be described. FIGS. 7 to 11 are flowcharts for explaining the information generation processing.

As illustrated in FIG. 7, the log transmission unit 215 of the physical machine 2 waits until the log collection unit 211 collects log information output from the business system SYS (NO in S21).

When the log collection unit 211 collects the log information output from the business system SYS (YES in S21), the log transmission unit 215 transmits the log information collected by the log collection unit 211 to the monitoring apparatus 1 (S22). In this case, the log transmission unit 215 transmits the log information collected by the log collection unit 211 to the storage device 3 (S23).

For example, every time the log collection unit 211 collects one new log of log information, the log transmission unit 215 transmits the new log of the log information to the monitoring apparatus 1 and the storage device 3.

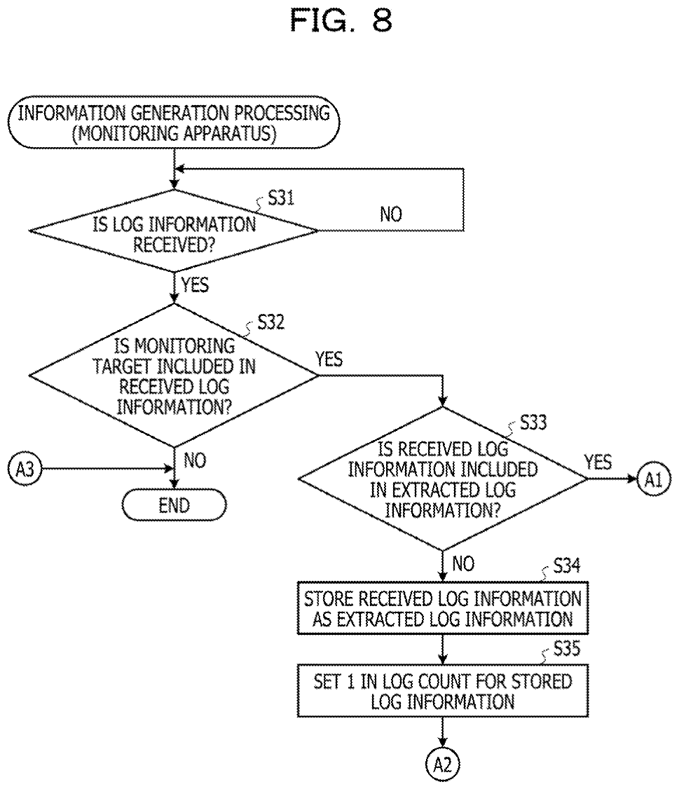

Meanwhile, as illustrated in FIG. 8, the log reception unit 111 of the monitoring apparatus 1 waits to receive the log information from any of the multiple physical machines 2 (NO in S31).

When the log information is received from any of the multiple physical machines 2 (YES in S31), the log extraction unit 112 of the monitoring apparatus 1 refers to the monitoring target information 131 stored in the information storage area 130 and thereby determines whether the log information received in the process in S31 includes a monitoring target character string (S32). A specific example of the monitoring target information 131 will be described below.

[Specific Example of Monitoring Target Information]

FIG. 14 is a diagram for explaining a specific example of the monitoring target information 131.

The monitoring target information 131 illustrated in FIG. 14 has an item of “CHARACTER STRING” for setting a monitoring target character string. In the monitoring target information 131 illustrated in FIG. 14, “Error” is set as the “CHARACTER STRING”.

Referring back to FIG. 8, when it is determined that the log information received in the process in S31 does not include any monitoring target character string (NO in S32), the monitoring apparatus 1 ends the information generation processing.

For example, when the log information received in the process in S31 does not include any monitoring target character string, the monitoring apparatus 1 determines that the log information received in the process in S31 does not have to be set as the monitoring target log information, and ends the information generation processing.

On the other hand, when determining that the log information received in the process in S31 includes the monitoring target character string (YES in S32), the log management unit 113 of the monitoring apparatus 1 refers to the extracted log information 132 stored in the information storage area 130 and thereby determines whether the same log information as the log information received in the process in S31 (log information that completely matches the log information received in the process in S31) is included in the extracted log information 132 (S33).

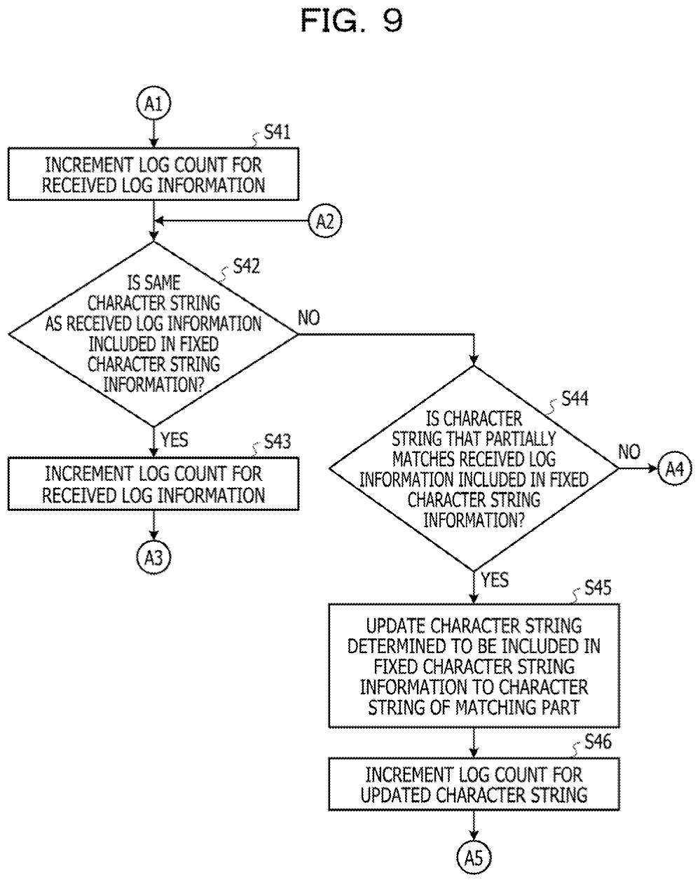

When determining that the same log information as the log information received in the process in S31 is included (YES in S33), the log management unit 113 increments a log count for the log information received in the process in S31 (the log information determined to be included in the process in S33) in the information included in the extracted log information 132 stored in the information storage area 130 as illustrated in FIG. 9 (S41). A specific example of the extracted log information 132 will be described below.

[Specific Examples of Extracted Log Information]

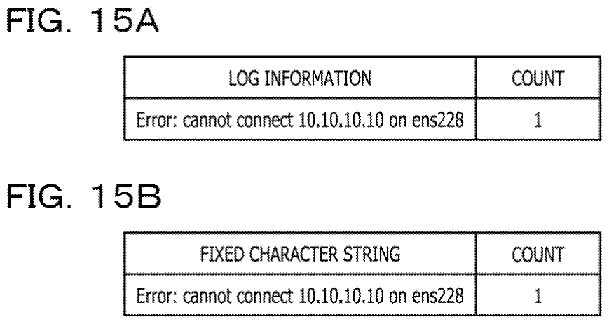

FIGS. 15A to 19C are diagrams for explaining specific examples of the extracted log information 132, the fixed character string information 133, and the variable character string information 134. FIGS. 15A, 16A, 17A, 18A, and 19A are diagrams for explaining specific examples of the extracted log information 132.

The extracted log information 132 illustrated in FIG. 15A and so on has items of “LOG INFORMATION” for setting a character string included in each log of the log information, and “COUNT” for setting the number of times that the log information including the character string set in the “LOG INFORMATION” has been received.

In the information in the first line of the extracted log information 132 illustrated in FIG. 15A, “Error: cannot connect 10.10.10.10 on ens228” is set as the “LOG INFORMATION” and “1 (count)” is set as the “COUNT”.

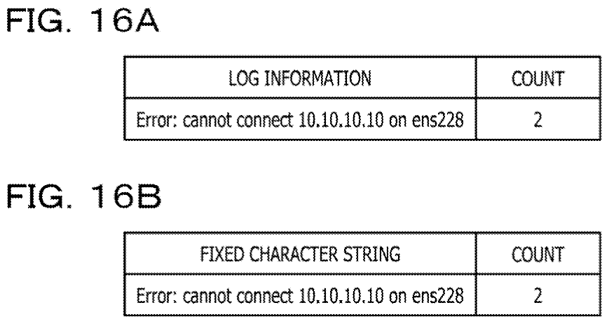

Thus, for example, when the extracted log information 132 illustrated in FIG. 15A is stored in the information storage area 130 and log information including the character string “Error: cannot connect 10.10.10.10 on ens228” is received, the log management unit 113 updates the “COUNT” of the information in which “Error: cannot connect 10.10.10.10 on ens228” is set as the “LOG INFORMATION” to “2 (counts)” as illustrated in FIG. 16A.

Referring back to FIG. 8, when determining that the same log information as the log information received in the process in S31 is not included (NO in S33), the log management unit 113 stores the log information received in the process in S31 into the information storage area 130 as one piece of the extracted log information 132 (S34).

The log management unit 113 sets “1” in the log count for the log information stored in the process in S34 in the information included in the extracted log information 132 stored in the information storage area 130 (S35).

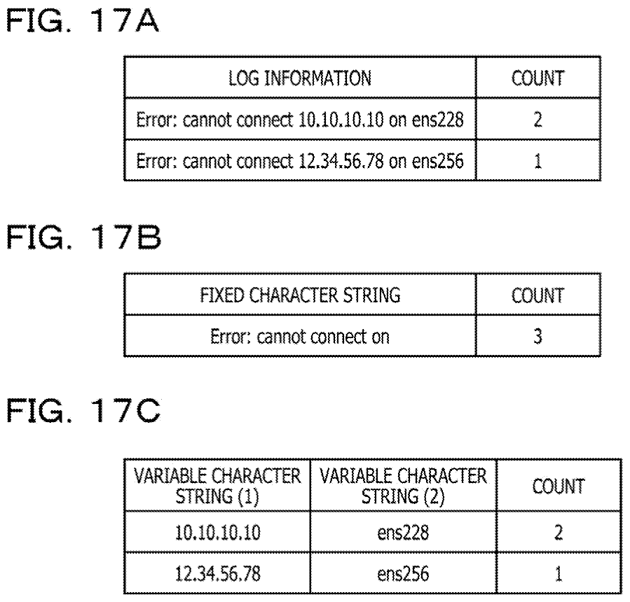

For example, when the extracted log information 132 illustrated in FIG. 16A is stored in the information storage area 130 and log information including a character string “Error: cannot connect 12.34.56.78 on ens256” is received, the log management unit 113 adds information in which “Error: cannot connect 12.34.56.78 on ens256” is set in the “LOG INFORMATION” and “1 (count)” is set in the “COUNT” as illustrated in the second line in FIG. 17A.

Referring back to FIG. 9, after the process in S35 or S41, the log management unit 113 refers to the fixed character string information 133 stored in the information storage area 130 and thereby determines whether the same character string as the log information received in the process in S31 is included in the fixed character string information 133 (S42).

When determining that the same character string as the character string included in the log information received in the process in S31 is included (YES in S42), the log management unit 113 increments the log count for the log information determined to be included in the process in S42 in the information included in the fixed character string information 133 stored in the information storage area 130 (S43). The monitoring apparatus 1 ends the information generation processing. Specific examples of the fixed character string information 133 will be described below.

[Specific Examples of Fixed Character String Information]

FIGS. 15B, 16B, 17B, 18B, and 19B are diagrams for explaining specific examples of the fixed character string information 133. The fixed character string information 133 illustrated in FIG. 15B and so on has items of “FIXED CHARACTER STRING” for setting each character string (character string of a fixed portion), and “COUNT” for setting the number of times that log information including the character string set in the “FIXED CHARACTER STRING” has been received.

In the information in the first line of the fixed character string information 133 illustrated in FIG. 15B, “Error: cannot connect 10.10.10.10 on ens228” is set as the “FIXED CHARACTER STRING” and “1 (count)” is set as the “COUNT”.

For this reason, for example, when the fixed character string information 133 illustrated in FIG. 15B is stored in the information storage area 130 and the log information including the character string “Error: cannot connect 10.10.10.10 on ens228” is further received, the log management unit 113 updates the “COUNT” of the information in which “Error: cannot connect 10.10.10.10 on ens228” is set as the “FIXED CHARACTER STRING” to “2 (counts)” as illustrated in FIG. 16B.

Referring back to FIG. 9, when determining that the same character string as the log information received in the process in S31 is not included (NO in S42), the log management unit 113 refers to the fixed character string information 133 stored in the information storage area 130 and thereby determines whether a character string that partially matches the log information received in the process in S31 is included in the fixed character string information 133 (S44).

When determining that the character string that partially matches the log information received in the process in S31 is included (YES in S44), the log management unit 113 updates the information included in the fixed character string information 133 stored in the information storage area 130 such that the character string determined to be included in the process in S44 is changed to the character string of the matching part determined to be included in the process in S44 (S45). The log management unit 113 increments the log count for the character string updated in S43 (S46).

For example, when multiple logs of log information including character strings that are partially in common (hereafter, also referred to as multiple logs of common log information) are received in the process in S31, the log management unit 113 manages a character string collectively for the common character strings in the multiple logs of the common log information among the character strings included in the fixed character string information 133 stored in the information storage area 130.

Thus, the monitoring apparatus 1 may reduce the number of character strings included in the fixed character string information 133. Therefore, the monitoring apparatus 1 may reduce a processing load for identifying monitoring target log information.

For example, when the fixed character string information 133 illustrated in FIG. 16B is stored in the information storage area 130 and log information including a character string “Error: cannot connect 12.34.56.78 on ens256” is received, the log management unit 113 determines that the character string completely matching the received log information is not included in the fixed character string information 133, but a character string, parts of which are character strings “Error: cannot connect” and “on” in common with the received log information, is included in the fixed character string information 133.

Therefore, as illustrated in FIG. 17B, the log management unit 113 updates, for example, “Error: cannot connect 10.10.10.10 on ens228” included in the fixed character string information 133 to “Error: cannot connect on”. For example, in this case, the log management unit 113 deletes “10.10.10.10” and “ens 228” that are parts of the character string not in common with the received log information from the character string included in “Error: cannot connect 10.10.10.10 on ens228”. As illustrated in FIG. 17B, the log management unit 113 updates, for example, the “COUNT” for the updated character string “Error: cannot connect on” to “3 (counts)”.

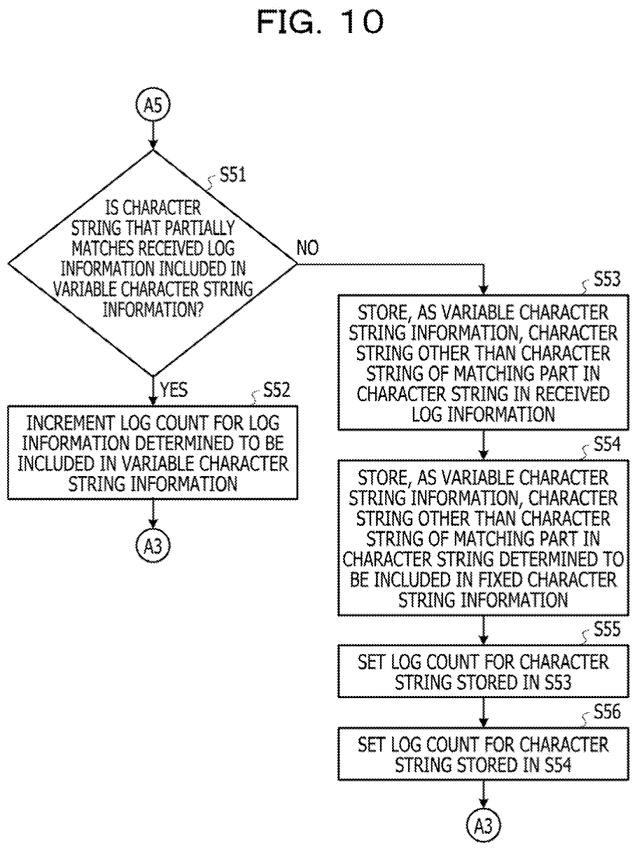

Referring back to FIG. 10, after the process in S46, the log management unit 113 refers to the variable character string information 134 stored in the information storage area 130 and thereby determines whether a character string that partially matches the log information received in the process in S31 is included in the variable character string information 134 (S51).

When determining that the character string that partially matches the log information received in the process in S31 is included (YES in S51), the log management unit 113 increments the log count for the log information determined to be included in the process in S51 in the information included in the variable character string information 134 stored in the information storage area 130 (S52). The monitoring apparatus 1 ends the information generation processing. Specific examples of the variable character string information 134 will be described below.

[Specific Examples of Variable Character String Information]

FIGS. 17C, 18C, and 19C are diagrams for explaining specific examples of the variable character string information 134. The variable character string information 134 illustrated in FIG. 17C and so on has items of “VARIABLE CHARACTER STRING” for setting each character string (character string of a variable portion), and “COUNT” for setting the number of times that log information including the character string set in the “VARIABLE CHARACTER STRING” has been received.

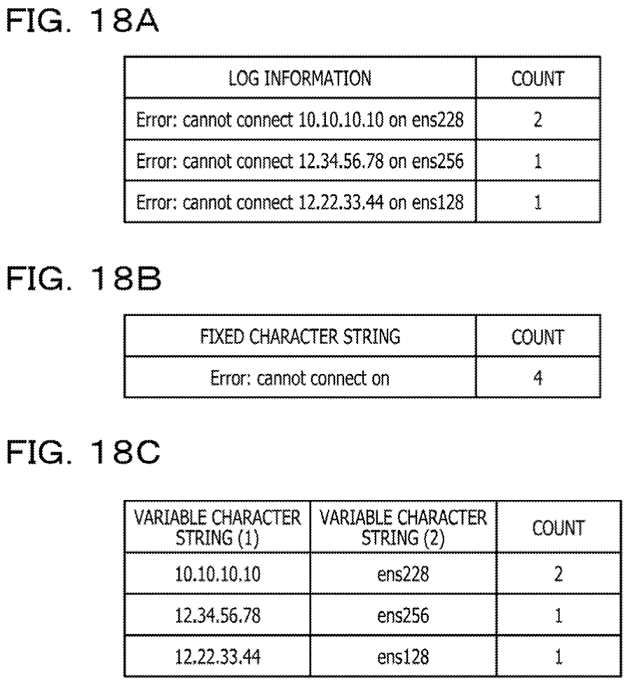

In the information in the third line of the variable character string information 134 illustrated in FIG. 18C, “12.22.33.44” is set as “VARIABLE CHARACTER STRING (1)”, “ens128” is set as “VARIABLE CHARACTER STRING (2)”, and “1 (count)” is set as the “COUNT”.

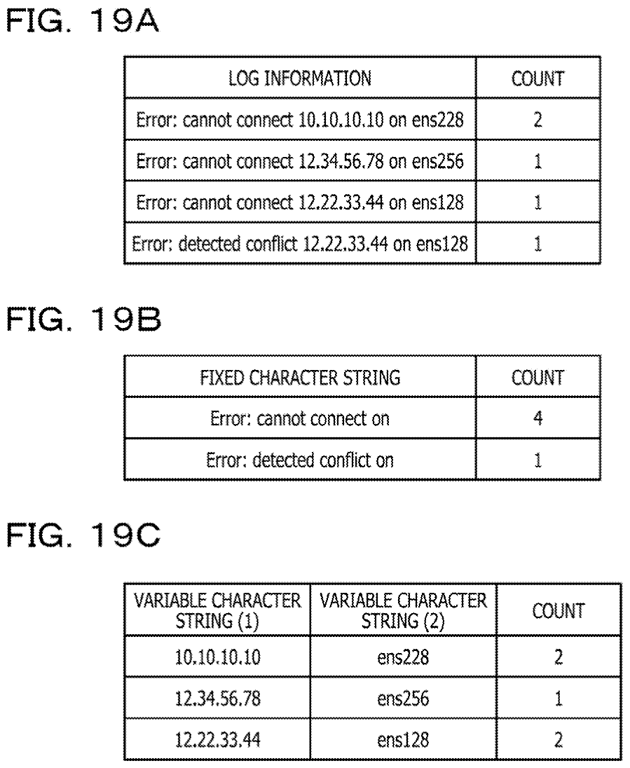

For this reason, for example, when the variable character string information 134 illustrated in FIG. 18C is stored in the information storage area 130 and log information including a character string “Error: detected conflict 12.22.33.44 on ens128” is received, the log management unit 113 updates the “COUNT” of the information in which “12.22.33.44” is set as the “VARIABLE CHARACTER STRING (1)” and “ens128” is set as the “VARIABLE CHARACTER STRING (2)” to “2 (counts)” as illustrated in the third line of FIG. 19C.

Referring back to FIG. 10, when determining that a character string that partially matches the log information received in the process in S31 is not included (NO in S51), the log management unit 113 stores, as one piece of the variable character string information 134 into the information storage area 130, a part of the character string in the log information received in the process in S31, the part being a character string other than the character string of the matching part determined to be included in the process in S44 (S53).

The log management unit 113 stores, as one piece of the variable character string information 134 into the information storage area 130, a part of the character string determined to be included in the process in S44, the part being a character string other than the character string of the matching part determined to be included in the process in S44 (S54).

The log management unit 113 sets the log count for the character string stored in the process in S53 in the information included in the variable character string information 134 stored in the information storage area 130 to be equal to the log count for the log information including the character string stored in the process in S53 in the information included in the extracted log information 132 stored in the information storage area 130 (S55).

The log management unit 113 sets the log count for the character string stored in the process in S54 in the information included in the variable character string information 134 stored in the information storage area 130 to be equal to the log count for the log information including the character string stored in the process in S54 in the information included in the extracted log information 132 stored in the information storage area 130 (S56). The monitoring apparatus 1 ends the information generation processing.

For example, when multiple logs of the common log information are received in the process in S31, the log management unit 113 updates the character string included in the fixed character string information 133 and stores, as the variable character string information 134, a character string not included in the fixed character string information 133 in each of the character strings included in the received multiple logs of the common log information.

Thus, as described later, the monitoring apparatus 1 is capable of identifying the monitoring target log information by using both the character strings included in the fixed character string information 133 and the character strings included in the variable character string information 134 without using definition values created in advance. Thus, the operator OP may easily manage the business system SYS.

For example, when the fixed character string information 133 illustrated in FIG. 16B is stored in the information storage area 130 and log information including a character string “Error: cannot connect 12.34.56.78 on ens256” is received, the log management unit 113 determines that the character string completely matching the received log information is not included in the fixed character string information 133, but a character string, parts of which are character strings “Error: cannot connect” and “on” in common with the received log information, is included in the fixed character string information 133.

For this reason, for example, when the variable character string information 134 is not generated yet, the log management unit 113 sets “10.10.10.10” and “ens 228”, which are parts of the character string other than “Error: cannot connect” and “on” in “Error: cannot connect 10.10.10.10 on ens228”, in the “VARIABLE CHARACTER STRING INFORMATION (1)” and the “VARIABLE CHARACTER STRING INFORMATION (2)”, respectively, and sets “2 (counts)” in the “COUNT” as illustrated in the first line of FIG. 17C. As illustrated in the second line of FIG. 17C, the log management unit 113 sets “12.34.56.78” and “ens256”, which are parts of the character string other than “Error: cannot connect” and “on” in “Error: cannot connect 12.34.56.78 on ens256”, in the “VARIABLE CHARACTER STRING INFORMATION (1)” and the “VARIABLE CHARACTER STRING INFORMATION (2)”, respectively, and sets “1 (count)” in the “COUNT”.

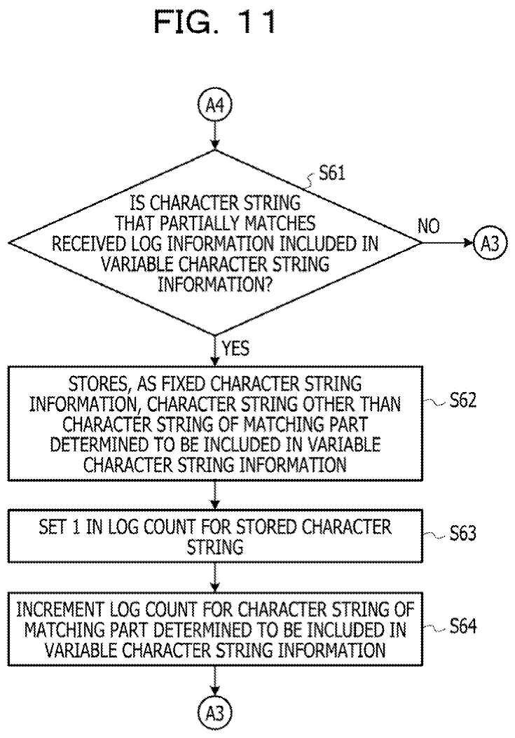

Referring back to FIG. 9, when determining that a character string that partially matches the log information received in the process in S31 is not included (NO in S44), the log management unit 113 refers to the variable character string information 134 stored in the information storage area 130 and thereby determines whether a character string that partially matches the log information received in the process in S31 is included in the variable character string information 134 (S61) as illustrated in FIG. 11.

For example, even when any part of the character string included in the log information received in the process in S31 is not included in the fixed character string information 133, there is a possibility that a part of the character string included in the log information received in the process in S31 may be included in the variable character string information 134. Thus, even when determining that any part of the character string included in the log information received in the process in S31 is not included in the fixed character string information 133, the log management unit 113 determines whether a part of the character string included in the log information received in the process in S31 is included in the variable character string information 134.

When determining that the character string that partially matches the log information received in the process in S31 is included (YES in S61), the log management unit 113 stores, as one piece of the fixed character string information 133 into the information storage area 130, a part of the character string included in the log information received in the process in S31, the part being a character string other than the character string of the matching part determined to be included in the process in S61 (S62).

The log management unit 113 sets “1” in the log count for the character string stored in the process in S62 in the information included in the fixed character string information 133 stored in the information storage area 130 (S63).

The log management unit 113 increments the log count for the character string of the matching part determined to be included in the process in S61 in the information included in the variable character string information 134 stored in the information storage area 130 (S64). The monitoring apparatus 1 ends the information generation processing.

For example, when the fixed character string information 133 illustrated in FIG. 18B is stored in the information storage area 130 and log information including a character string “Error: detected conflict 12.22.33.44 on ens128” is received, the log management unit 113 determines that the same character string as the received log information is not included in the fixed character string information 133, and that a character string that is partially in common with the received log information is not included in the fixed character string information 133. On the other hand, for example, when the variable character string information 134 illustrated in FIG. 18C is stored in the information storage area 130, the log management unit 113 determines that “12.22.33.44” and “ens128” included in the received log information are included in the variable character string information 134.

Therefore, the log management unit 113 updates the “COUNT” of the information in which “12.22.33.44” and “ens128” are set in the “VARIABLE CHARACTER STRING (1)” and the “VARIABLE CHARACTER STRING (2)”, respectively, to “2 (counts)” as illustrated in the third line of FIG. 19C. As illustrated in the second line of FIG. 19B, the log management unit 113 sets “Error: detected conflict on”, which is a character string obtained by deleting “12.22.33.44” and “ens128” from the character string “Error: detected conflict 12.22.33.44 on ens128” included in the received log information, in the “FIXED CHARACTER STRING”, and sets “1 (count)” in the “COUNT”.

Referring back to FIG. 11, when determining that a character string that partially matches the log information received in the process in S31 is not included (NO in S61), the monitoring apparatus 1 ends the information generation processing.

[Log Monitoring Processing]

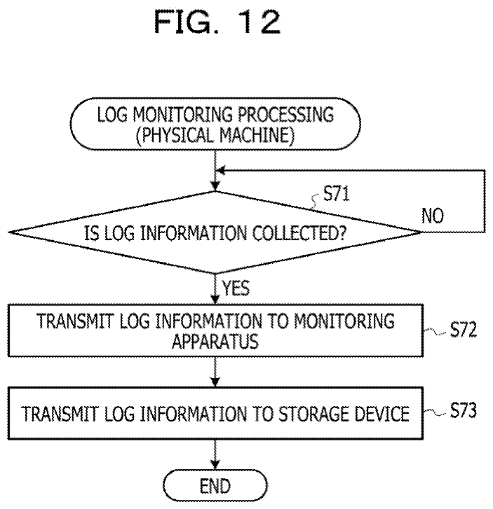

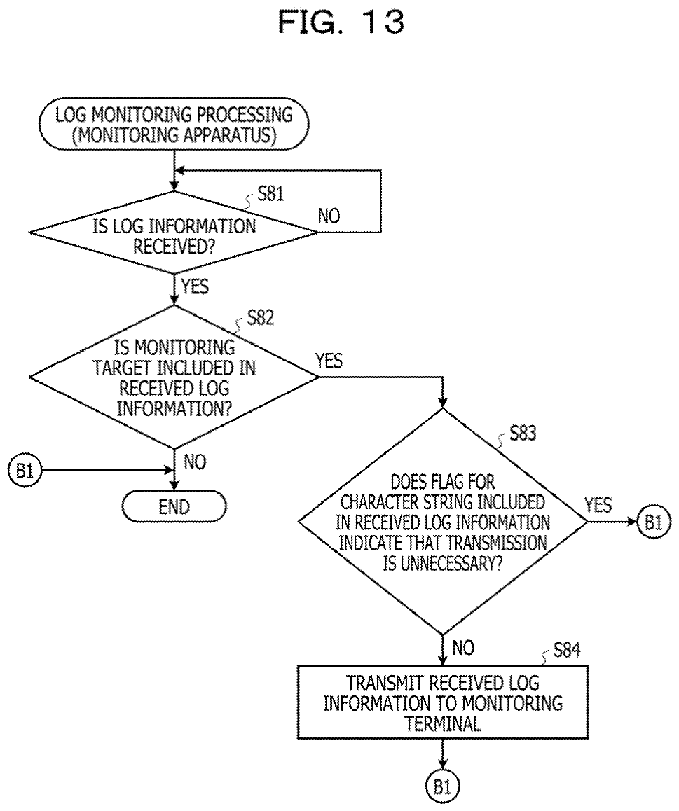

Next, the log monitoring processing will be described. FIGS. 12 and 13 are flowcharts for explaining the log monitoring processing.

As illustrated in FIG. 12, the log transmission unit 215 waits until the log collection unit 211 collects the log information output from the business system SYS (NO in S71).

When the log collection unit 211 collects the log information output from the business system SYS (YES in S71), the log transmission unit 215 transmits the log information collected by the log collection unit 211 to the monitoring apparatus 1 (S72). In this case, the log transmission unit 215 transmits the log information collected by the log collection unit 211 to the storage device 3 (S73).

Meanwhile, as illustrated in FIG. 13, the log reception unit 111 waits to receive the log information from any of the multiple physical machines 2 (NO in S81).

When the log information is received from any of the multiple physical machines 2 (YES in S81), the log extraction unit 112 refers to the monitoring target information 131 stored in the information storage area 130 and thereby determines whether the log information received in the process in S81 includes a monitoring target character string (S82).

When it is determined that the log information received in the process in S81 does not include any monitoring target character string (NO in S82), the monitoring apparatus 1 ends the log monitoring processing.

On the other hand, when it is determined that the monitoring target character string is included in the log information received in the process in S81 (YES in S82), the log identification unit 114 of the monitoring apparatus 1 refers to the fixed character string information 133 and the monitoring necessity information 135 stored in the information storage area 130 and thereby determines whether a flag for the character string included in the log information received in the process in S81 indicates that the transmission is unnecessary (S83). Specific examples of the monitoring necessity information 135 associated with the fixed character string information 133 (hereafter, also referred to as monitoring necessity information 135a) will be described below.

[Specific Example of Monitoring Necessity Information (1)]

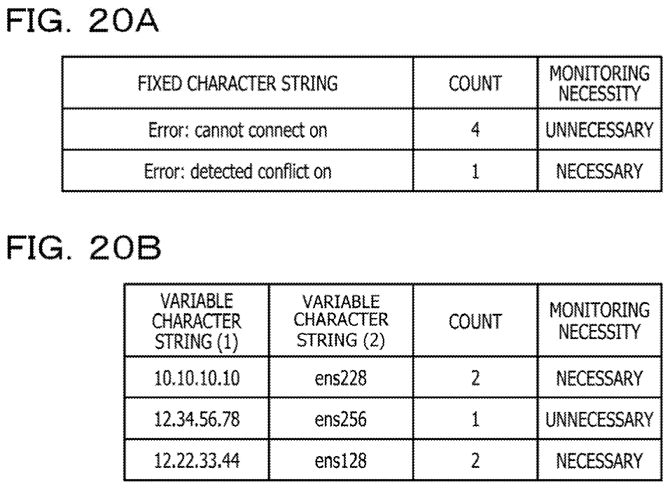

FIGS. 20A and 20B are diagrams for explaining specific examples of the monitoring necessity information 135. FIG. 20A is a specific example of the monitoring necessity information 135a associated with the fixed character string information 133 explained with reference to FIG. 19B.

The monitoring necessity information 135a illustrated in FIG. 20A includes an item of “MONITORING NECESSITY” for setting whether each character string is required to be monitored in addition to the items included in the fixed character string information 133 explained with reference to FIG. 15B and so on. In the “MONITORING NECESSITY”, for example, “NECESSARY” indicating that each character string is required to be monitored or “UNNECESSARY” indicating that each character string is not required to be monitored is set.

In the information in the first line of the monitoring necessity information 135a illustrated in FIG. 20A, “Error: cannot connect on” is set as the “FIXED CHARACTER STRING”, “4 (counts)” is set as the “COUNT”, and “UNNECESSARY” is set as the “MONITORING NECESSITY”. Description of the other information included in FIG. 20A is omitted herein.

Thus, for example, when log information including a character string “Error: cannot connect 10.10.10.10 on ens228” is received, the log management unit 113 refers to the monitoring necessity information 135a illustrated in FIG. 20A and thereby determines that the flag for the character string included in the log information received in the process in S81 indicates that the transmission is unnecessary.

Referring back to FIG. 13, when the log identification unit 114 determines that the flag for the character string included in the log information received in the process in S81 indicates that the transmission is unnecessary by referring to the fixed character string information 133 and the monitoring necessity information 135 stored in the information storage area 130 (YES in S83), the monitoring apparatus 1 ends the log monitoring processing.

On the other hand, when the log identification unit 114 determines that the flag for the character string included in the log information received in the process in S81 does not indicate that the transmission is unnecessary by referring to the fixed character string information 133 and the monitoring necessity information 135 stored in the information storage area 130, the log identification unit 114 further refers to the variable character string information 134 and the monitoring necessity information 135 stored in the information storage area 130 and thereby determines whether the flag for the character string included in the log information received in the process in S81 indicates that the transmission is unnecessary (S83). A specific example of the monitoring necessity information 135 associated with the variable character string information 134 (hereafter, also referred to as monitoring necessity information 135b) will be described below.

[Specific Example of Monitoring Necessity Information (2)]

FIG. 20B is a specific example of the monitoring necessity information 135b associated with the variable character string information 134 explained with reference to FIG. 19C.

The monitoring necessity information 135b illustrated in FIG. 20B has an item of “MONITORING NECESSITY” for setting whether each character string is required to be monitored in addition to the items included in the variable character string information 134 explained with reference to FIG. 17C and so on.

In the information in the first line in the variable character string information 134 and the monitoring necessity information 135 illustrated in FIG. 20B, “10.10.10.10” is set as the “variable character string (1)”, “ens 228” is set as the “VARIABLE CHARACTER STRING (2)”, “2 (counts)” is set as the “COUNT”, and “NECESSARY” is set as the “MONITORING NECESSITY”. Description of the other information included in FIG. 20B is omitted herein.

Thus, for example, when log information including a character string “Error: cannot connect 10.10.10.10 on ens228” is received, the log management unit 113 refers to the monitoring necessity information 135b illustrated in FIG. 20B and thereby determines that the flag for the character string included in the log information received in the process in S81 indicates that the transmission is necessary.

Referring back to FIG. 13, when the log identification unit 114 determines that the flag for the character string included in the log information received in the process in S81 indicates that the transmission is unnecessary by referring to the variable character string information 134 and the monitoring necessity information 135 stored in the information storage area 130 (YES in S83), the monitoring apparatus 1 ends the log monitoring processing.

On the other hand, when the log identification unit 114 determines that the flag for the character string included in the log information received in the process in S81 does not indicate that the transmission is unnecessary by referring to the variable character string information 134 and the monitoring necessity information 135 stored in the information storage area 130 (NO in S83), the log transmission unit 115 of the monitoring apparatus 1 transmits the log information received in the process in S81 to the operation terminal 5, for example (S84). Then, the monitoring apparatus 1 ends the log monitoring processing.

For example, when the transmission of both of the character string of the fixed portion and the character string of the variable portion included in the log information received in the process in S81 is necessary, the log transmission unit 115 determines the log information received in the process in S81 as a monitoring target log.

Thus, the monitoring apparatus 1 is capable of transmitting, to the operation terminal 5, only the log information determined to be required to be a monitoring target log in the log information received in the process in S81. Therefore, for the operator OP, it is possible to reduce the number of monitoring target logs required to be monitored.

As described above, the monitoring apparatus 1 according to the present embodiment extracts multiple logs of target log information each including a predetermined character string from multiple logs of first log information output from the business system SYS. The monitoring apparatus 1 stores the character string of a fixed portion and the character string of a variable portion included in each of the extracted multiple logs of the target log information into the storage unit.

After that, the monitoring apparatus 1 extracts multiple logs of candidate log information each including the predetermined character string from multiple logs of second log information output from the business system SYS. The monitoring apparatus 1 identifies one or more monitoring target logs from the extracted multiple candidate logs based on the monitoring necessity information specifying whether each of the character strings of the fixed portions and the character strings of the variable portions stored in the storage unit is a character string required to be monitored. The monitoring apparatus 1 transmits, for example, the one or more identified monitoring target logs to the operation terminal 5.

For example, the monitoring apparatus 1 according to the present embodiment stores the character strings included in the multiple logs of the target log information extracted from the multiple logs of the first log information such that the character strings of the fixed portions and the character strings of the variable portions are stored separately into the information storage area 130a and the information storage area 130b, respectively. Then, the operator OP inputs, to the monitoring apparatus 1, the monitoring necessity information specifying whether each of the character strings of the fixed portions stored in the information storage area 130a and the character strings of the variable portions stored in the information storage area 130b is a character string required to be monitored, for example.

After that, for example, for each of the multiple logs of the candidate log information extracted from the multiple logs of the second log information different from the multiple logs of the first log information, the monitoring apparatus 1 determines whether each of the character string of the fixed portion and the character string of the variable portion included in the concerned log of the candidate log information is a character string required to be monitored by referring to the monitoring necessity information input by the operator OP. The monitoring apparatus 1 identifies a monitoring target log from the multiple logs of the candidate log information based on the respective determination results for the multiple logs of the candidate log information.

In this way, the monitoring apparatus 1 according to the present embodiment is capable of generating, from the log information, the definition values (monitoring necessity information 135) for use to monitor the business system SYS. Thus, it is possible for the operator OP to reduce a work burden involved in manual creation and update of definition values, and to easily manage the business system SYS, for example.

By reducing the log information transmitted to the operation terminal 5, the monitoring apparatus 1 is capable of reducing the number of logs of the log information required to be checked by the operator OP for managing the business system SYS. Thus, it is possible for the operator OP to reduce the work burden involved in the management of the business system SYS. As a result, for example, the operator OP is enabled to quickly take a countermeasure against an abnormality occurring in the business system SYS and inhibit the occurring abnormality from influencing the services.

By referring to the information set as the “COUNT” in the extracted log information 132, the fixed character string information 133, the variable character string information 134, and the monitoring necessity information 135, the operator OP may check the occurrences of log information including a monitoring target character string.

[Overview of Second Embodiment]

Next, an overview of log management processing according to a second embodiment will be described.

The log management processing in the second embodiment is different from the log management processing in the first embodiment in that, for example, multiple physical machines 2 also perform the log management processing performed by the monitoring apparatus 1 in the first embodiment.

In the first embodiment described with reference to FIGS. 1 to 20B, the monitoring apparatus 1 performs the log management processing in order to reduce the burden on the operator OP for monitoring the business system SYS. In contrast, in the second embodiment, each of the multiple physical machines 2 performs the log management processing in order to conceal (hereafter, also referred to as mask) a character string determinable to contain personal information or the like of a user among character strings included in log information output by the business system SYS.

Although the following description will be given on the assumption that the monitoring apparatus 1 also performs the log management processing (the log management processing in the first embodiment), only the multiple physical machines 2 may perform the log management processing (the log management processing in the second embodiment).

[Functions of Information Processing System in Second Embodiment]

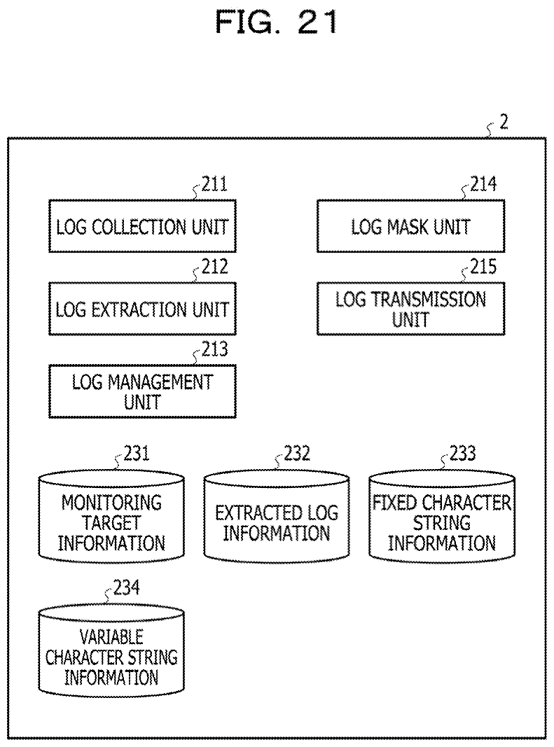

Next, functions of an information processing system 10 according to the second embodiment will be described. FIG. 21 is a functional block diagram of the physical machine 2 according to the second embodiment. FIG. 21 may be rephrased as a block diagram illustrating functions involved in execution of the log management processing among functions of the physical machine 2. Only differences from the first embodiment will be described below.

As illustrated in FIG. 21, the physical machine 2 implements various functions including a log collection unit 211, a log extraction unit 212, a log management unit 213, a log mask unit 214, and a log transmission unit 215 through organic collaboration of hardware such as the CPU 201 and the memory 202 with the program 210, for example.

For example, as illustrated in FIG. 21, each of the multiple physical machines 2 stores monitoring target information 231, extracted log information 232, fixed character string information 233, and variable character string information 234 in an information storage area 230. The monitoring target information 231, the extracted log information 232, the fixed character string information 233, and the variable character string information 234 are information having the same contents as the monitoring target information 131, the extracted log information 132, the fixed character string information 133, and the variable character string information 134 explained with reference to FIGS. 15A, 15B, and so on.

First, description will be given of functions for performing processing of generating the fixed character string information 233 and the variable character string information 234 (hereafter, also referred to information generation processing) in the log management processing.

The log collection unit 211 of each physical machine 2 collects multiple logs of log information (multiple logs of first log information) output from the business system SYS running on the physical machine 2.

For example, the log extraction unit 212 refers to the monitoring target information 231 stored in the information storage area 230 and extracts multiple logs of log information (multiple logs of target log information) each including any of character strings specified in the monitoring target information 231 (predetermined character strings) from the multiple logs of the log information collected by the log collection unit 211. Then, the log extraction unit 212 stores the extracted multiple logs of the log information into the information storage area 230 as the extracted log information 232.

The log management unit 213 stores a character string of a fixed portion included in each of the multiple logs of the log information extracted by the log extraction unit 212 into the information storage area 230 as the fixed character string information 233.

The log management unit 213 stores a character string of a variable portion included in each of the multiple logs of the log information extracted by the log extraction unit 212 into the information storage area 230 as the variable character string information 234.

Next, description will be given of functions for performing processing of masking log information by using the fixed character string information 233 and the variable character string information 234 (hereafter, also referred to as log mask processing) in the log management processing.

The log collection unit 211 of each physical machine 2 collects multiple logs of log information (multiple logs of second log information) output from the business system SYS running on the physical machine 2.

For example, by referring to the monitoring target information 231 stored in the information storage area 230, the log extraction unit 212 extracts multiple logs of log information (multiple logs of candidate log information) each including any of character strings specified in the monitoring target information 231 (predetermined character strings) from the multiple logs of the log information received by the log collection unit 211.

By referring to the variable character string information 234 stored in the information storage area 230, the log mask unit 214 identifies log information including a character string to be masked (hereafter, also referred to as mask target log information) from the multiple logs of the log information extracted by the log extraction unit 212. Then, the log mask unit 214 masks the character string to be masked among the character strings included in the identified mask target log information.

For example, by referring to the variable character string information 234 stored in the information storage area 230, the log mask unit 214 determines whether each of the multiple logs of the log information extracted by the log extraction unit 212 includes a character string included in the variable character string information 234. Then, the log mask unit 214 identifies, as the mask target log information, log information determined to include the character string included in the variable character string information 234 among the multiple logs of the log information extracted by the log extraction unit 212. After that, the log mask unit 214 masks the character string included in the variable character string information 234 among the character strings included in the identified mask target log information.

The log transmission unit 215 transmits, for example, the log information collected by the log collection unit 211 (including the log information including the character string masked by the log mask unit 214) to the monitoring apparatus 1 and the storage device 3.

[Details of Second Embodiment]

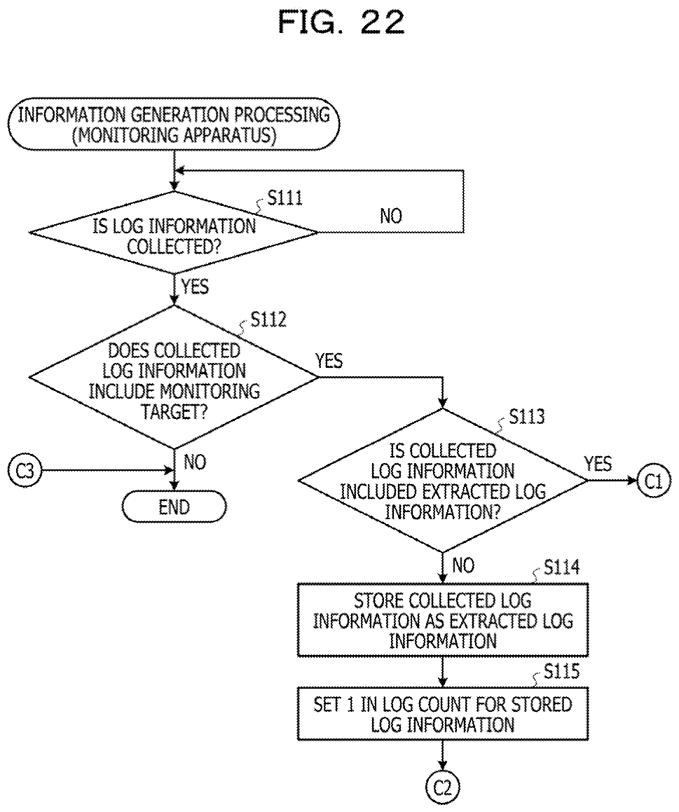

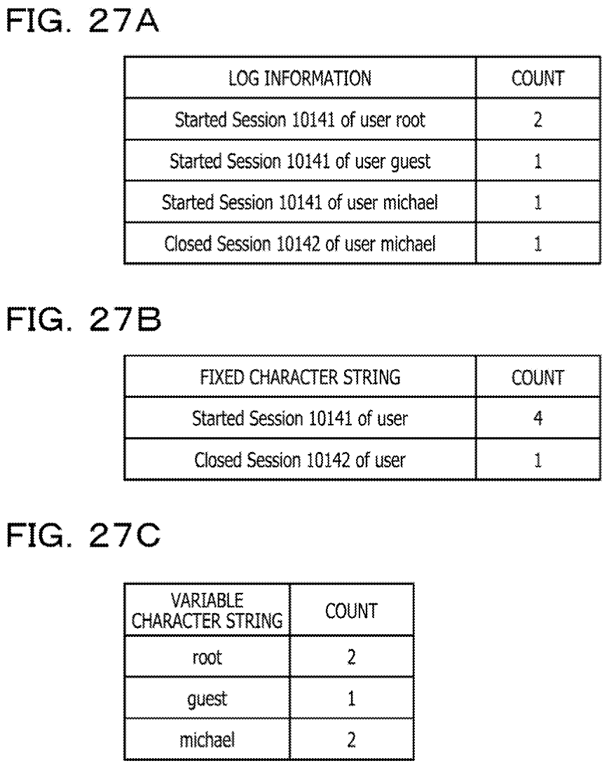

Next, details of the second embodiment will be described. FIGS. 22 to 26 are flowcharts for explaining the details of the log management processing according to the second embodiment. FIGS. 27A to 27C are diagrams for explaining the log management processing according to the second embodiment.

[Information Generation Processing]

First, information generation processing according to the second embodiment will be described. FIGS. 22 to 25 are flowcharts for explaining the information generation processing according to the second embodiment.

As illustrated in FIG. 22, the log collection unit 211 of each physical machine 2 waits to collect the log information output from the business system SYS running on the physical machine 2 (NO in S111).

When the log information output from the business system SYS is collected (“YES” in S111), the log extraction unit 212 of the physical machine 2 refers to the monitoring target information 231 stored in the information storage area 230 and thereby determines whether the log information collected in the process in S111 includes a monitoring target character string (S112). For example, “User” may be set as a monitoring target character string in the monitoring target information 231.

When the log extraction unit 212 determines that the log information collected in the process in S111 does not include any monitoring target character string (NO in S112), the physical machine 2 ends the information generation processing.

For example, when the log information collected in the process in S111 does not include any monitoring target character string, the physical machine 2 determines that it is unnecessary to mask the character string included in the log information collected in the process in S111, and ends the information generation processing.

On the other hand, when the log extraction unit 212 determines that the log information collected in the process in S111 includes a monitoring target character string (YES in S112), the log management unit 213 of the physical machine 2 refers to the extracted log information 232 stored in the information storage area 230 and thereby determines whether the same log information as the log information collected in the process in S111 is included in the extracted log information 232 (S113).

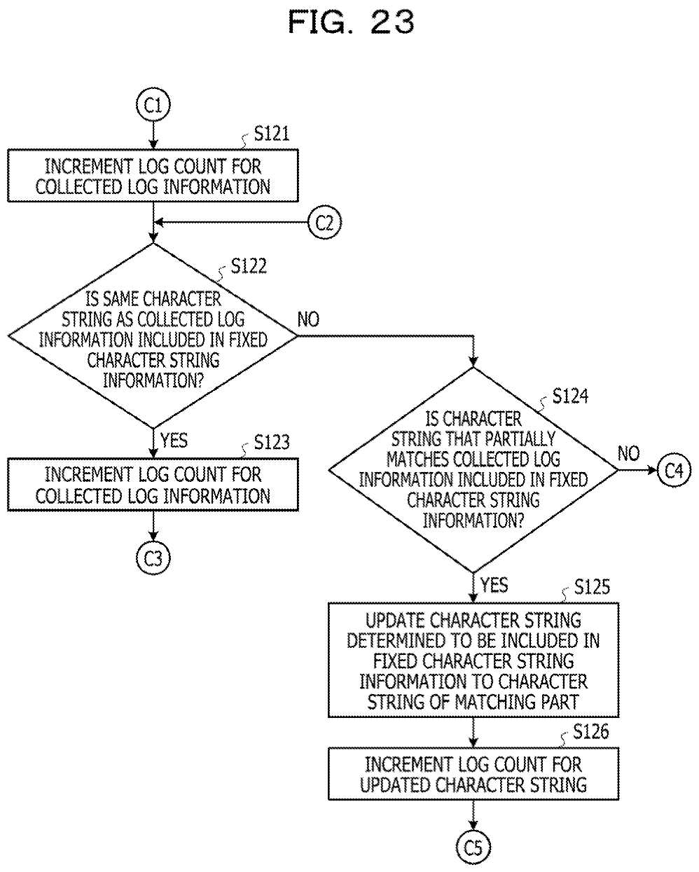

When determining that the same log information as the log information collected in the process in S111 is included (YES in S113), the log management unit 213 increments the log count for the log information collected in the process in S111 (the log information determined to be included in the process in S113) in the information included in the extracted log information 232 stored in the information storage area 230 (S121) as illustrated in FIG. 23.

On the other hand, when determining that the same log information as the log information collected in the process in S111 is not included (NO in S113), the log management unit 213 stores the log information collected in the process in S111 into the information storage area 230 as one piece of the extracted log information 232 (S114).

The log management unit 213 sets “1” in the log count for the log information stored in the process in S114 in the information included in the extracted log information 232 stored in the information storage area 230 (S115).

After the process in S115 or S121, the log management unit 213 refers to the fixed character string information 233 stored in the information storage area 230 and thereby determines whether the same character string as the log information collected in the process in S111 is included in the fixed character string information 233 (S122).

When determining that the same character string as the log information collected in the process in S111 is included (YES in S122), the log management unit 213 increments the log count for the log information determined to be included in the process in S122 in the information included in the fixed character string information 233 stored in the information storage area 230 (S123). Then, the physical machine 2 ends the information generation processing.

On the other hand, when determining that the same character string as the log information collected in the process in S111 is not included (NO in S122), the log management unit 213 refers to the fixed character string information 233 stored in the information storage area 230 and thereby determines whether a character string that partially matches the log information collected in the process in S111 is included in the fixed character string information 233 (S124).

When determining that a character string that partially matches the log information collected in the process in S111 is included (YES in S124), the log management unit 213 updates the information included in the fixed character string information 233 stored in the information storage area 230 such that the character string determined to be included in the process in S124 is changed to the character string of the matching part determined to be included in the process in S124 (S125). The log management unit 213 increments the log count for the character string updated in the process in S125 (S126).

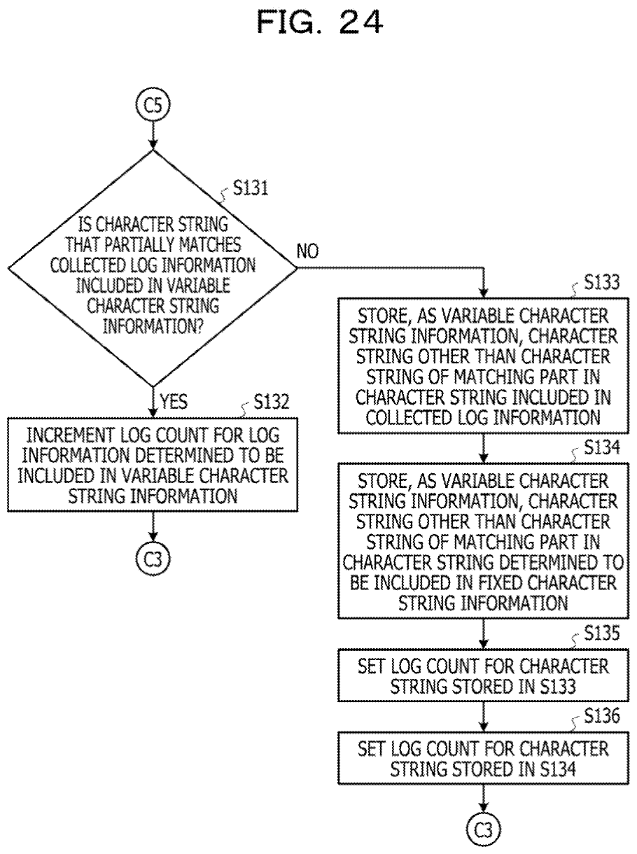

As illustrated in FIG. 24, by referring to the variable character string information 234 stored in the information storage area 230, the log management unit 213 determines whether a character string that partially matches the log information collected in the process in S111 is included in the variable character string information 234 (S131).

When determining that a character string that partially matches the log information collected in the process in S111 is included (YES in S131), the log management unit 213 increments the log count for the log information determined to be included in the process in S131 in the information included in the variable character string information 234 stored in the information storage area 230 (S132). Then, the physical machine 2 ends the information generation processing.

On the other hand, when determining that any character string that partially matches the log information collected in the process in S111 is not included (NO in S131), the log management unit 213 stores, as one piece of the variable character string information 234 in the information storage area 230, a part of the character string included in the log information collected in the process in S111, the part being a character string other than the character string of the matching part determined to be included in the process in S124 (S133).

The log management unit 213 stores, as one piece of the variable character string information 234 into the information storage area 230, a part of the character string determined to be included in the process in S124, the part being a character string other than the character string of the matching part determined to be included in the process in S124 (S134).

The log management unit 213 sets the log count for the character string stored in the process in S133 in the information included in the variable character string information 234 stored in the information storage area 230 to be equal to the log count for the log information including the character string stored in the process in S133 in the information included in the extracted log information 232 stored in the information storage area 230 (S135).

The log management unit 213 sets the log count for the character string stored in the process in S134 in the information included in the variable character string information 234 stored in the information storage area 230 to be equal to the log count for the log information including the character string stored in the process in S134 in the information included in the extracted log information 232 stored in the information storage area 230 (S136). Then, the physical machine 2 ends the information generation processing.

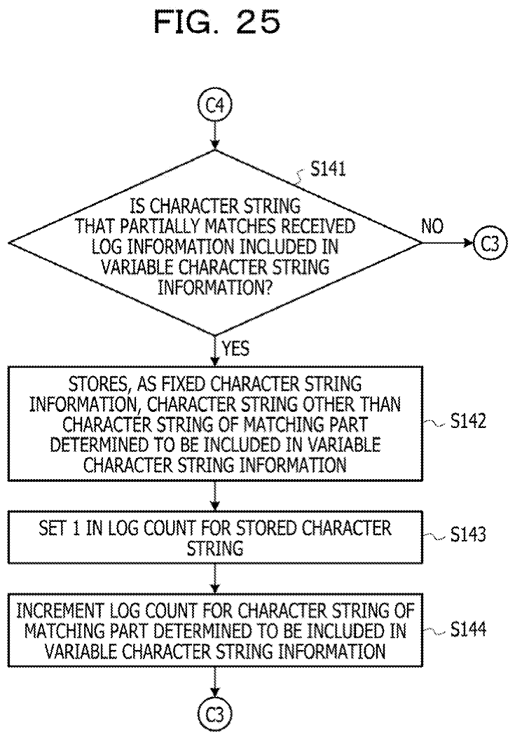

When determining that any character string that partially matches the log information collected in the process in S111 is not included (NO in S124), the log management unit 213 refers to the variable character string information 234 stored in the information storage area 230 and thereby determines whether a character string that partially matches the log information collected in the process in S111 is included in the variable character string information 234 (S141) as illustrated in FIG. 25.

When determining that a character string that partially matches the log information collected in the process in S111 is included (YES in S141), the log management unit 113 stores, as one piece of the fixed character string information 233 into the information storage area 230, a part of the character string included in the log information collected in the process in S111, the part being a character string other than the character string of the matching part determined to be included in the process in S141 (S142).

The log management unit 213 sets “1” in the log count for the character string stored in the processing in step S142 in the information included in the fixed character string information 233 stored in the information storage area 230 (S143).

The log management unit 213 increments the log count for the character string of the matching part determined to be included in the process in S141 in the information included in the variable character string information 234 stored in the information storage area 230 (S144). Then, the physical machine 2 ends the information generation processing.

On the other hand, when the log management unit 213 determines that any character string that partially matches the log information collected in the process in S111 is not included (NO in S141), the physical machine 2 ends the information generation processing.

[Log Mask Processing]

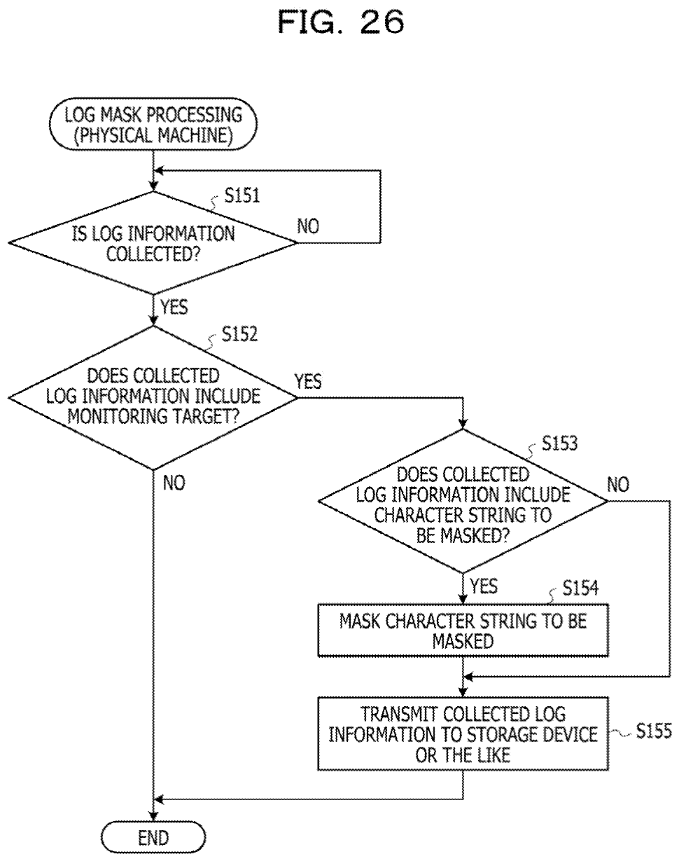

Next, the log mask processing according to the second embodiment will be described. FIG. 26 is a flowchart for explaining the log mask processing according to the second embodiment.

As illustrated in FIG. 26, the log collection unit 211 of each physical machine 2 waits to collect the log information output from the business system SYS running on the physical machine 2 (NO in S151).

When the log information output from the business system SYS is collected (“YES” in S151), the log extraction unit 212 refers to the monitoring target information 231 stored in the information storage area 230 and thereby determines whether the log information collected in the process in S151 includes a monitoring target character string (S152).

When it is determined that the log information collected in the process in S151 does not include any monitoring target character string (NO in S152), the physical machine 2 ends the log mask processing.

On the other hand, when it is determined that the log information collected in the process in S151 includes a monitoring target character string (YES in S152), the log mask unit 214 of the physical machine 2 refers to the variable character string information 234 stored in the information storage area 230 and thereby determines whether the log information collected in the process in S151 includes a character string to be masked (S153).

The log mask unit 214 determines whether the character string included in the log information collected in the process in S151 includes a character string included in the variable character string information 234.

When determining that the log information collected in the process in S151 includes a character string to be masked (YES in S153), the log mask unit 214 masks the character string to be masked which is determined to be included in the process in S153 (S154).

On the other hand, when determining that the log information collected in the process in S151 does not include any character string to be masked (NO in S153), the log mask unit 214 skips the process in S154.

For example, the log transmission unit 215 transmits the log information collected in the process in S151 (including the log information masked in the process in S154) to the monitoring apparatus 1 and the storage device 3 (S155). Then, the physical machine 2 ends the log monitoring processing. Specific examples of the extracted log information 232, the fixed character string information 233, and the variable character string information 234 according to the second embodiment will be described below.

[Specific Examples of Extracted Log Information, Fixed Character String Information, and Variable Character String Information]

FIGS. 27A to 27C are diagrams for explaining the specific examples of the extracted log information 232, the fixed character string information 233, and the variable character string information 234 according to the second embodiment. FIG. 27A is a diagram for explaining the extracted log information 232 according to the second embodiment, FIG. 27B is a diagram for explaining the fixed character string information 233 according to the second embodiment, and FIG. 27C is a diagram for explaining the variable character string information 234 according to the second embodiment.

In the information in the first line of the extracted log information 232 illustrated in FIG. 27A, “Started Session 10141 of user root” is set as the “LOG INFORMATION” and “2 (counts)” is set as the “COUNT”. In the information in the second line of the extracted log information 232 illustrated in FIG. 27A, “Started Session 10141 of user guest” is set as the “LOG INFORMATION” and “1 (count)” is set as the “COUNT”. In the information in the third line of the extracted log information 232 illustrated in FIG. 27A, “Started Session 10141 of user michael” is set as the “LOG INFORMATION” and “1 (count)” is set as the “COUNT”. In the information in the fourth line of the extracted log information 232 illustrated in FIG. 27A, “Closed Session 10142 of user michael” is set as the “LOG INFORMATION” and “1 (count)” is set as the “COUNT”.

In the extracted log information 232 illustrated in FIG. 27A, information in which the character string including “Started Session 10141 of user” is set in the “LOG INFORMATION” is the information in the first, second, and third lines. In the extracted log information 232 illustrated in FIG. 27A, the total of the counts set for the “LOG INFORMATION” in the information in the first, second, and third lines is “4 (counts)”.

Thus, in the information in the first line of the fixed character string information 133 illustrated in FIG. 27B, “Started Session 10141 of user” is set as the “FIXED CHARACTER STRING” and “4 (counts)” is set as the “COUNT”.

Similarly, in the information in the second line of the fixed character string information 133 illustrated in FIG. 27B, “Closed Session 10142 of user” is set as the “FIXED CHARACTER STRING” and “1 (count)” is set as the “COUNT”.

In the extracted log information 232 illustrated in FIG. 27A, the information in which the character string including “root” is set in the “LOG INFORMATION” is only in the first line. In the extracted log information 232 illustrated in FIG. 27A, the information set in the “COUNT” in the information in the first line is “2 (counts)”.

Thus, in the information in the first line of the variable character string information 234 illustrated in FIG. 27C, “root” is set as the “VARIABLE CHARACTER STRING” and “2 (counts)” is set as the “COUNT”.

Similarly, in the information in the second line of the variable character string information 234 illustrated in FIG. 27C, “guest” is set as the “VARIABLE CHARACTER STRING” and “1 (count)” is set as the “COUNT”. In the information in the third line of the variable character string information 234 illustrated in FIG. 27C, “michael” is set as the “VARIABLE CHARACTER STRING” and “2 (counts)” is set as the “COUNT”.

For example, the variable character string information 234 illustrated in FIG. 27C indicates that, when a character string included in the log information collected in the process in S151 includes any of the character strings “root”, “guest”, and “michael”, the character string is to be masked.

As described above, the physical machine 2 according to the present embodiment extracts multiple logs of the target log information including a predetermined character string from multiple logs of the first log information. The physical machine 2 stores, into the information storage area 230, the character string of the variable portion included in each of the extracted multiple target logs.

Thereafter, the physical machine 2 extracts multiple candidate logs including the predetermined character string from multiple second logs. The physical machine 2 conceals the character string of the variable portion included in each of the multiple candidate logs by referring to the character strings of the variable portions stored in the information storage area 230. The physical machine 2 transmits, for example, the multiple candidate logs in which the character strings of the variable portions are concealed to the storage device 3.

For example, the physical machine 2 according to the present embodiment determines that the character string of the variable portion in the character string included in the log information output by the business system SYS is a character string concerning user's personal information or the like, and conceals the character string.

Thus, for example, the physical machine 2 according to the present embodiment is capable of concealing a character string included in the log information output from the business system SYS without preparing, in advance, definition values required to identify character strings to be concealed. Therefore, it is possible for the operator OP to reduce the work burden for creating or updating definition values, and to easily make concealment in the log information output from the business system SYS.

For example, the physical machine 2 according to the present embodiment is capable of concealing a character string included in the log information output from the business system SYS inside the physical machine 2. Thus, for example, even when the network between the physical machine 2 and the storage device 3 is an external network such as the Internet, the physical machine 2 may avoid leakage of the content in the log information transmitted to the storage device 3 to the outside.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a log management program for causing a computer to execute a process comprising:
extracting a plurality of logs of target log information including a predetermined character string from a plurality of first logs;
storing, into a memory, a character string of a fixed portion and a character string of a variable portion included in each of the plurality of logs of the target log information thus extracted;
extracting a plurality of logs of candidate log information including the predetermined character string from a plurality of second logs;
identifying one or more logs of monitoring target log information from the plurality of logs of the candidate log information based on monitoring necessity information specifying whether each of the character strings of the fixed portions and the character strings of the variable portions stored in the memory is a character string required to be monitored; and
transmitting the identified one or more logs of the monitoring target log information to a different apparatus.

2. The non-transitory computer-readable recording medium according to claim 1, wherein
the storing includes
determining whether there is a first common character string that is common to a character string included in first target log information included in the plurality of logs of the target log information and a first character string included in the character strings of the fixed portions stored in the memory, and
when it is determined that the first common character string exists, updating the first character string stored in the memory to the first common character string and storing a character string in the first target log information other than the first common character string and a character string in the first character string other than the first common character string into the memory as character strings of the variable portions.

3. The non-transitory computer-readable recording medium according to claim 2, wherein
the storing includes
when it is determined that the first common character string does not exist, determining whether there is a second common character string that is common to a character string included in the first target log information included in the plurality of logs of the target log information and a second character string included in the character strings of the variable portions stored in the memory, and
when it is determined that the second common character string exists, storing a character string in the first target log information other than the second common character string into the memory as a character string of the fixed portion.

4. The non-transitory computer-readable recording medium according to claim 3, wherein
the storing includes
when it is determined that the second common character string does not exist, storing the character string included in the first target log information into the memory as a character string of the fixed portion.

5. The non-transitory computer-readable recording medium according to claim 1, wherein
the identifying includes identifying, as the one or more logs of the monitoring target log information from the plurality of logs of the candidate log information, one or more logs each including the character string of the fixed portion and the character string of the variable portion both of which are specified as the character strings required to be monitored in the monitoring necessity information.

6. The non-transitory computer-readable recording medium according to claim 5, wherein the program further causes the computer to execute a process comprising:
when the monitoring necessity information input is received, storing the received monitoring necessity information into the memory.

7. A non-transitory computer-readable recording medium storing a log management program for causing a computer to execute a process comprising:
extracting a plurality of logs of target log information including a predetermined character string from a plurality of first logs;
storing, into a memory, a character string of a variable portion included in each of the plurality of logs of the target log information thus extracted;
extracting a plurality of logs of candidate log information including the predetermined character string from a plurality of second logs;
concealing the character string of the variable portion included in each of the plurality of logs of the candidate log information by referring to the character strings of the variable portions stored in the memory; and
transmitting the plurality of logs of the candidate log information in each of which the character string of the variable portion is concealed to a different apparatus.

8. An information processing apparatus comprising:
a memory; and
a processor coupled to the memory and configured to:
extract a plurality of logs of target log information including a predetermined character string from a plurality of first logs;
store, into the memory, a character string of a fixed portion and a character string of a variable portion included in each of the plurality of logs of the target log information thus extracted;
extract a plurality of logs of candidate log information including the predetermined character string from a plurality of second logs;
identify one or more logs of monitoring target log information from the plurality of logs of the candidate log information based on monitoring necessity information specifying whether each of the character strings of the fixed portions and the character strings of the variable portions stored in the memory is a character string required to be monitored; and
transmit the identified one or more logs of the monitoring target log information to a different apparatus.
